(19) United States
(12) Patent Application Publication
(10) Pub. No.: US 2003/0140670 A1
(43) Pub. Date: Jul. 31, 2003

(54) Method of sustaining plant growth in toxic substrates polluted with heavy metal elements

(76) Inventor: Peter J. Leggo, Cambridge (GB)

Correspondence Address: Stephen R. Dunn, 1144 EDGEMONT ROAD N.W., CALGARY, AB, T3A 2J8, CA

(21) Appl. No.: 10/184,911

(22) Filed: Jul. 1, 2002

Related U.S. Application Data
(60) Provisional application No. 60/305,631, filed on Jul. 17, 2001.

(51) Int. Cl. C05F 1/00

(52) U.S. Cl. 71/15

(57) ABSTRACT

A method of sustaining plant growth in toxic substrates polluted with heavy metal elements, characterized in that it comprises amendment and remediation of the toxic substrates with an organo-zeolitic mixture. Vegetation, such as hyperaccumulator plants or native plants and grasses for in situ remediation, will now grow. The method can also be used as a fertilizer and for beneficiation of normal, uncontaminated soils.

Activities in the Industrial Age have resulted in the deposit of high levels of many metals in certain sites, to the point that human life is seriously threatened. Metal-production activities, such as mining or smelting, as well as the ubiquitous use of metals, have created many sites where toxic metals have become concentrated in soils.

In recent years, efforts have been made to develop phyto-remediation methods, e.g., the use of metal-accumulating plants called metallophytes to remove contaminating metals from sites. It has been known for some time that many plant species will concentrate certain metals in their leaves, stems and roots to a varying degree.

For heavy metals, two different types of phyto-remediation methods can be distinguished:

rhizofiltration, by concentration of heavy metals in plant roots;

photo-stabilization, the roots of the plants limiting heavy metals' availability and limiting mobility of said metals into the groundwater.

More than 400 phyto-remediators are known, most of them absorbing Nickel. The most rarely absorbed heavy metals include Manganese, Cadmium and Lead.

Various metallophytes have been tested, such as Brassicaceae (Thlaspi brachypetal, Thlaspi ochroleucum, Thlaspi caerulescens, Thlaspi rotundifolium, Cardaminopsis halleri), Caroyphyllaceae (Minuartia verna, Polycarpea synandra), Fabaceae (Astragalus Pectinatus, Astragalus bisculatus), Myriophyllium verticullatum, Pshychotrai douerreer, Viola calaminaria.

Document U.S. Pat. No. 6,917,117 relates to a method by which hyperaccumulation of metals in plant shoots such as Brassicaceae (e.g., Brassica, Sinapsis, Thlaspi, Alyssum, Eruca) is induced by exposure to phytotoxic inducing agents such as chelating agents (e.g., Roundup®) and high concentrations of heavy metals. The exposure to the inducing agent is made after a period of plant growth, as metal accumulation into plant shoots has dramatic effects on plant growth. The use of phytotoxic inducing agents as described in document U.S. Pat. No. 5,917,117 is non-ecological and potentially dangerous for the operator.

Document U.S. Pat. No. 5,711,784 discloses a method of extracting nickel, cobalt and other metals including the platinum palladium metal families from soil by phytomining. The conditions include 1) lowering the soil pH by addition of sulphur and use of ammonium N fertilizers, 2) maintaining low Ca in the soil by acidification of the soil with sulphur or sulphuric acid, and 3) applying chelating agents to the soil, such as NTA.

The method in document U.S. Pat. No. 5,711,784 is complicated and non-ecological. Document U.S. Pat. No. 5,927,005 relates to a method of removing heavy metals from soil using creosote plants (Lacrea tridentate). Again, to increase the rate of metal uptake in the plants, it is proposed to increase the acidity or to add chelators to the soil in which the creosote bushes are growing.

Other phyto-remediation techniques are described in documents WO-A-00/28093, WO-A-00/31308, WO-A-98/59080, WO-A-94/01357, EP-A-0 911 387, JP-A-57.000.190, DE-A-41.00758, DE-A-39.21336, U.S. Pat. No. 5,100,455, U.S. Pat. No. 5,320,663, U.S. Pat. No. 5,364,451, U.S. Pat. No. 5,785,735, U.S. Pat. No. 5,809,693, U.S. Pat. No. 5,853,576, U.S. Pat. No. 5,928,406, U.S. Pat. No. 5,944,872, U.S. Pat. No. 6,117,462.

Despite increasing interest and research, several problems associated with phyto-remediation remain. For example, some metals in contaminated areas may be hardly reached via phyto-remediation because they lie beneath the rhizosphère, many of the known metal-accumulating plants being simply too small to accumulate large quantities of metals. Additionally, many of the plants thus far identified as useful in phyto-remediation are from tropical regions.

One object of the invention is to provide means of preventing surface erosion, especially for toxic substances polluted with heavy metal elements.

Another object of the invention is to provide means of promoting growth of metallophytes and other plants on toxic ground polluted by the presence of heavy metal elements.

Another object of the invention is to provide the above-mentioned means, said means being ecological and less expensive than most known bio-remediation methods.

According to the invention, there is provided a method of sustaining plant growth in toxic substrates polluted with heavy metal elements, characterized in that it comprises amendment of the toxic substrates with an organo-zeolitic mixture.

The heavy metal element(s) can be the typical ones, such as Zinc, Copper, Lead, Cadmium, Arsenic, Mercury, etc., the organo-zeolitic mixture being added to the said polluted substrate between 5% and 40%.

The method of the present invention can be used to sustain the growth of various plants, especially plant root growth in toxic substrates polluted with heavy metal elements.

Normally, owing to the lack of available nitrogen and other essential nutrient elements, ground containing high levels of toxic metals would not sustain plant growth to a level that will prevent surface erosion. By amending the ground with the organo-zeolitic fertilizer, this condition can be overcome by growing plants with very dense root systems.

The method of the present invention can be manipulated to very the shoot-to-root ratio of the plant species used. In this respect, plants which concentrate heavy metals such as Zn, Cd and Cu in their shoots can be grown successfully and cropped to remove the metals from the rhizosphere.

The method of the present invention will enable the metal-enriched plant tissue, on ashing, to be reduced to a small volume which can be disposed of easily by mixing with zeolite-amended Portland cement and used in the production of concretes that are known to have high compressive strengths.

More precisely, after harvesting and ashing the plant, the heavy metal cations contained in the ash may be put into aqueous solution and ion-exchanged into a zeolitic tuff. The resulting zeolitic material can be dried and used to produce blended cements which have improved compressive strength and are also known to reduce the expansion caused by alkali-aggregate reactions.

It is known that natural zeolite minerals can be used as biological fertilizer (see for instance JP-A-10210855, JP-A-41971 10, EP-A-444392, U.S. Pat. No. 5,082,488, U.S. Pat. No.5,451,242, U.S. Pat. No. 5,900,387, RU-A-2 121 777, RU-A-2 132 122, RU-A-2 137 340). The preparation of an organic fertilizer incorporating zeolitic tuft is described in document U.S. Pat. No. 4,559,073, the inclusion of the zeolitic component being claimed to lower the water content of the mixture to allow effective aerobic fermentation.

Document U.S. Pat. No. 5,106,405 discloses the property of ion-exchanging ammonium ions that, via soil microbial reactions, would supply available nitrogen to plants growing in a substrate amended with a bio-fertilizer containing a zeolitic component.

The inventor has discovered that natural zeolite materials could be used to prepare a biological fertilizer which can be applied to ground contaminated with heavy metal cations to enable the sustainable growth of plants and to control the development of shoot-to-root in such a way that plant morphology can be adjusted to either maximize soil retention by dense root growth or increase the foliage uptake of toxic heavy metal ions.

If untreated, such ground will not support vegetation and becomes subject to surface erosion by wind and rain. Toxic material transported by these agents into local drainage patterns is thus isolated and therefore uncontrollable.

Specific implementation of the invention will now be described, by way of the invention as claimed herein. Any variations in the exemplified compositions and methods which occur to the man skilled in the art are intended to fall within the scope of the present invention.

Example:

A clay-rich toxic soil containing: 2.87% Organic matter, 1.1% Calcium carbonate, 2.2% total Iron, 28.9 mg.kg⁻¹ Zinc, 670 mg.kg⁻¹ Lead, 12.2% mg.kg⁻¹ Cadmium and 18.9 mg.kg⁻¹ Arsenic has been amended with 16.7% organo-zeolitic fertilizer.

Organo-zeolitic fertilizer is prepared as follows:

Animal waste, e.g., chicken manure, is composted together with crushed zeolitic tuft containing the zeolite Ca, K, Clinoptilolite in a ratio of 1:2 (by volume) i.e., tuft to manure. The materials are mixed together with enough water to make the pile damp and choppen straw is added. Air is forced through the pile from (a) perforated plastic pipe(s) laid inside the pile during construction and the reaction is carried out under cover. This could prevent saturation of the pile with rain water.

The pile reaches 50-70° C. and then the temperature drops to ambient, at which stage the composted material is dry, friable, odourless and ready for use as an organo-zeolitic fertilizer.

Spring Wheat (Triticum aestivum L., cv. Red Fife) was sown in two-kilogram substrates. Wheat grown in the untreated soil was used for comparison. The plants were grown in 255 mm-diameter pots, replicated four times, under ordinary lighting conditions in a greenhouse. Watering, with de-ionized water, was by weight to field capacity (180 ml per 2-kg substrate) and the pots were placed in shallow trays to retain leachate. Watering, generally on a daily basis, prevented the plants from drying out and any water running from the pots was returned to the substrate surface with little loss. Plants were harvested on a regular basis each month and the shoot weights were recorded after drying to constant weight at 70° C.

One month after germination the substrates were leached with 400 ml of de-ionized water (pH=8.4) and, after removal of fine colloidal particles, were analyzed chemically. Two further leachate collections were made at monthly intervals over a three-month growth period.

Leachate chemistry at the third harvest

| | | | |
|---|---|---|---|
| Toxic substrate | N conc | 0.23 | mg/l |
| Amended substrate | N conc | 178.00 | mg/l |
| Toxic substrate | K conc | 17.38 | mg/l |
| Amended substrate | K conc | 66.70 | mg/l |
| Toxic substrate | Ca conc | 20.40 | mg/l |
| Amended substrate | Ca conc | 253.00 | mg/l |
| Toxic substrate | Mg conc | 2.69 | mg/l |
| Amended substrate | Mg conc | 27.10 | mg/l |
| Toxic substrate | pH 7.8 | E.C. 149 | μS/cm |
| Amended substrate | pH 7.2 | E.C. 2077 | μS/cm |

These results demonstrate the degree of mobilization of major cations in the amended soil solution.

In the case of the metal trace elements, a general decrease is seen in the leachates between high concentrations in the toxic substrates and low concentrations in the amended substrates. An example is shown below for Zinc.

| | | |
|---|---|---|
| Toxic substrate: | Zn conc | 0.65 mg/l |
| Amended substrate: | Zn conc | 0.65 mg/l |

Following the analysis of the leachates, the chemical analyses of the plant shoots express the way in which nutrient and trace metal elements are taken up from the respective substrates.

Plant shoot chemistry at the third harvest

| | Amended Substrate | | Toxic Substrate | |
|---|---|---|---|---|
| N conc | 2.19 | wt % | 1.16 | wt % |
| K conc | 35.33 | mg/g | 18.20 | mg/g |
| Ca conc | 5.82 | mg/g | 2.82 | mg/g |
| Mg conc | 1.24 | mg/g | 0.85 | mg/g |
| Zn conc | 124 | μg/g | 67 | μg/g |
| Pb conc | 5 | μg/g | 3 | μg/g |
| Cu conc | 17 | μg/g | 5 | μg/g |

The plant shoot chemistry can now be compared to the established nutrient range for Spring Wheat.

| | % dry wt | | | | | μg/g | |
|---|---|---|---|---|---|---|---|
| | N | P | K | Ca | Mg | Zn | Cu |
| Adequate | 3.0-4.5 | 0.3-0.5 | 2.9-3.8 | 0.4-1.0 | 0.15- | 20-70 | 5-10 |
| range: | | | | | 0.3 | | |
| Toxic | 1.16 | 0.5 | 1.80 | 0.3 | 0.10 | 67 | 5 |
| substrate: | | | | | | | |
| Amended | 2.19 | 0.3 | 3.50 | 0.6 | 0.12 | 124 | 17 |
| substrate: | | | | | | | |

Shoot dry weight recorded at monthly harvests

| | Dry weight (g/plant) |
|---|---|
| 1st harvest | |
| Toxic substrate: | 0.26 |
| Amended substrate: | 0.89 |
| 2nd harvest | |
| Toxic substrate: | 0.52 |
| Amended substrate: | 5.36 |
| 3rd harvest | |
| Toxic substrate: | 1.03 |
| Amended substrate: | 6.77 |

Comments on example

The type of organo-zeolitic fertilizer of the present invention can be adapted to grow plants with a dense root system on toxic soils that cannot normally supply sufficient plant nutrients to support such growth. This is achieved by microbiological means only, as no inorganic mineral salts have been added.

It can be seen from the chemistry of the plant shoots that when the available nitrogen in the substrate is some 35% below the adequate range, a dense root system (in the case of Spring Wheat) is formed. As the percentage of organo-zeolitic material added to the toxic soil can be altered, the concentration of available nitrogen can be adjusted to suit the plant species concerned. If maximum shoot growth is required, then the percentage of organo-zeolitic material can be adjusted upwards to put the nitrogen concentration into the adequate range. This would be desired if maximum plant uptake was required in order to remove heavy metals from the rhizosphere.

The trace element concentrations of Zinc and Copper in the plant shoots show that the mobilization of cations in the soil solution, due to the microbial activity of the organo-zeolitic material, make these elements available to the plant. On harvesting, the soil will be partially depleted in these elements and in time the rhizosphere will become less polluted. The volume of plant material after harvest can be greatly reduced by ashing and can be safely stored or possibly recycled.

As it is known that the addition of finely crushed zeolitic tuft to Portland cement improves its physical and chemical properties, the suggestion is made that heavy metal cations remaining in the plant ash could be exchanged into zeolitic tuft which is afterwards used for such a purpose.

Possible explanation

A proposed explanation of the above-mentioned results is given below, the detailed mechanism still being the subject of research by the inventor. During organo-zeolitic fertilizer preparation, choppen straw likely provides a source of carbon to support bacterial growth. Ammonifying bacteria (as typified by Clostridium and Penicillium) acting on the organic material decompose proteins, amino sugars and nucleic acids to ammonia. The ammonia in the cationic form NH4+ is ion-exchanged into the zeolite where it is held, loosely bound, within the pore space of the crystal lattice. The bacterial activity causes the increase of temperature up to 50-70° C., the completion of the reaction being reached as the temperature drops to ambient.

On addition of the fertilizer to a plant substrate, the NH4+ ions held in the zeolite pore space diffuse at an exponential rate into the substrate. Nitrifying bacteria present in the organo-zeolitic component use the diffusing NH4+ to produce a large source of nitrate that is used in plant growth. As a consequence of the bacterial reactions, free hydrogen ions (protons) are liberated and mobilize the soil solution, causing the dissociation of metal cations present in the substrate.

The inventor has demonstrated how the organo-zeolitic fertilizer can be used with soils polluted with heavy metals such as Zinc, Cadmium, Copper and Lead. The inventor has now found that when 16-17% organo-zeolitic fertilizer is added to such soils, similar effects occur which greatly increase nitrate concentration and mobilize metal cations in the soil solution.

Amending a toxic soil in this way slightly lowers the pH of the soil solution but increases its electrical conductivity by an order of magnitude. At the level of amendment quoted (16-17%), twice the amount of available nitrogen present in the toxic soil is provided. This increase is 35% below the adequate range for Spring Wheat (Triticum aestivum L., cv. Red Fife) and has the effect of maximizing the root/shoot ratio. In this way a dense root system can be developed. By increasing the amount of organo-zeolitic fertilizer added to the soil, the root-to-shoot ratio can be decreases, in which case shoot growth is favoured.

Cation mobilization in the soil solution provides the growing plant with nutrients such as Potassium, Calcium, Magnesium and Zinc, and the plant's requirement acts to buffer the system against concentration of these elements and diffusion from the rhizosphere. By increasing the level of plant nutrients in this way a healthy plant can be grown and sustained on toxic soils polluted with heavy metals. In the case of Zinc and Copper, the inventor has observed that these elements are taken up by the plant at a rate that can be tolerated, and the damage occurring in the same plants grown in the toxic soil is not seen. This property can be used to remove heavy metal elements from the rhizosphere by harvesting the plant. The plant material can be greatly reduced in volume by ashing without loss of the heavy metals and incorporated in a mixture of Portland cement and finely crushed zeolitic tuff. In this way, concrete of high compressive strength and low alkali reactivity can be made and used to store the heavy metal elements.

Land contaminated, poisoned and polluted by industrial and mining operations is a terrible problem. These toxic sites are an extreme danger to the environment and to the health of people who live nearby.

These toxic lands, upon which only very sparse vegetation can grow (if it can grow at all), have erosion rates 100 to 1000 times higher than lands covered by full-rooted, permanent vegetation.

It is vital to fully realize that once these poisonous metals (lead, mercury, cadmium, zinc, copper, nickel, etc.) are blown as a fine dust by the wind, they are impossible to control. The result is contamination and pollution of the air we breathe, the water we drink (and eventually the ground water), and inevitably the food chain itself. It is, therefore, crucial to develop a method which treats the problem in situ.

A very important part of the invention is to treat toxic substrates polluted with heavy metal elements in situ. Contaminated surface sites have erosion rates which are 100 to 1000 times higher than on land covered by permanent vegetation. Native grasses and plants planted with our organo-zeolitic mixture increase the root growth significantly and increase the retention of soil particles and heavy metals, thus they will remain in situ.

Acidic soils present a particularly difficult problem to overcome in the revegetation of soils contaminated with mine wastes. This is often due to the continual oxidation of sulphide minerals, generating sulphuric acid which lowers the pH of the soil solution. Nitrification rates begin to decrease below pH 6.0 and become negligible below 4.5. The consequence is that it becomes impossible to grow plants in soils with pH values below 3. Recent work has shown that the zeolitic component of the bio-fertilizer acts to increase soil pH to a level at which nitrifying bacteria can survive and multiply.

Statement

Work on Ryegrass (Lolium perenne L.) has shown that amendment of the plant substrate with the zeolite bio-fertilizer will enhance plant growth in a similar way to that seen with Spring Wheat (Triticum aestivum L., cv.Paragon).

Dense root systems can be sustained in soils polluted with heavy metals. The contaminated substrate used was identical to that in the spring wheat programme as described in the above patent.

In the ryegrass programme un-ammoniated zeolitite (i.e. zeolitised volcanic tuff containing the zeolite mineral clinoptilolite) was added in varying proportions to the initial amended substrate containing 16-17 (volume %) organo-zeolitic fertilizer (zeolite bio-fertilizer).

The exchangable cations in the clinoptilolite used are Calcium and Potassium. Zeolite minerals with appreciable quantities (>ca.2 Wt %) are undesirable as reactions in the plant substrate increase the sodium availability which can cause depression in growth. The typical formula of the clinoptilolite used is: (K _{1.9}Ca_{1.3} Na_{0.4}Mg _{0.1}) Al _{6.1} Si_{2.99} O₇₂ 23.1 H₂O

It was found that the relationship between shoot dry weight and weight % excess zeolitite defined the (cut-off) Limit of growth enhancement above which continued addition of zeolitite diminished plant growth.

This effect was found to vary according to plant density. A low density group (25 plants/pot) having a higher cut-off limit than a high density group (ca. 600 plants/pot).

The low density plants also showed greater growth enhancement than the high density group.

Analytical data: Shoot dry weights

| | Shoot |
|---|---|
| Plant substrate | weight (g) |
| (i) Low density group harvested at four months | |
| Gp.1 Toxic substrate | 7.38 |
| Gp.2 Amended substrate, (16-17) vol % zeolite bio- | 31.46 |
| fertilizer | |
| Gp.3 Ditto + 75 wt % un-amoniated zeolitite | 32.73 |
| Gp.4 Ditto + 150 wt % un-amoniated zeolitite | 33.36 |
| Gp.5 Ditto + 225 wt % un-ammoniated zeolitite | 33.98 |
| Gp.6 Ditto + 300 wt % un-ammoniated zeolitite | 28.87 |
| (ii) High density group harvested at five months. | |
| Gp.1 Toxic substrate | 6.76 |
| Gp.2 Amended substrate (16-17) vol % zeolite bio-fertilizer | 25.83 |
| Gp.3 Ditto + 75 wt % un-ammoniated zeolitite | 26.49 |
| Gp.4 Ditto + 150 wt % un-ammoniated zeolitite | 25.46 |
| Gp.5 Ditto + 225 wt % un-ammoniated zeolitite | 25.10 |
| Gp.6 Ditto + 300 wt % un-ammoniated zeolitite | 24.51 |

Statement

The root systems in the low density group show a decline in root mass above an excess addition of 150 wt % un-ammoniated zeolitite.

As in the case of the shoot mass a distinct cut-off is seen in root growth. In the present case, working with heavy metals in the specified range in neutral to slightly alkaline conditions no advantage is gained in increasing the excess zeolitite above 150 wt %. Whereas shoot growth is maximised at 225 wt % excess zeolitite.

This again demonstrates that the bio-fertilizer can be formulated to maximise either shoot or root growth.

In order to formulate the bio-fertilizer for these effects it will be necessary to conduct initial laboratory trials as the biological factors (i.e. remedial plant species and density), bacterial population, soil properties, heavy metal species and concentrations will vary independently at specific sites.

Analytical data: Root dry weights

| | Root |
|---|---|
| Plant substrate | weight (g) |
| (i) Low density group harvested at five months. | |
| Gp.1 Toxic substrate | 3.45 |
| Gp.2 Amended substrate (16-17) vol % zeolite bio-fertilizer | 6.53 |
| Gp.3 Ditto + 75 wt % un-ammoniated zeolitite | 8.43 |
| Gp.4 Ditto + 150 wt % un-ammoniated zeolitite | 11.80 |
| Gp.5 Ditto + 225 wt % un-ammoniated zeolitite | 11.67 |
| Gp.6 Ditto + 300 wt % un-ammoniated zeolitite | 7.44 |

Statement

Harvested plant shoots in the high density group were analysed for trace concentrations of Zinc, Copper and Lead. By relating the trace metal chemistry to the shoot dry weight of the amended groups it was found that the cut-off limit corresponded to a concentration of 138 μg.g⁻¹ Zinc. Above this value shoot dry weight dropped dramatically.

Analytical data: Trace metal chemistry in shoots

| | μg. g⁻¹ | | |
|---|---|---|---|
| Plant substrate | Zn | Pb | Cu |
| Gp.1 Toxic substrate | 74.2 | 6.7 | 16.1 |
| Gp.2 Amended substrate (16-17) vol % zeolite bio- | 106.7 | 6.8 | 22.2 |
| fertilizer | | | |
| Gp.3 Ditto + 75 wt % un-ammoniated zeolitite | 138.1 | 6.1 | 26.0 |
| Gp.4 Ditto + 150 wt % un-ammoniated zeolitite | 140.6 | 7.6 | 24.6 |
| Gp.5 Ditto + 225 wt % un-ammoniated zeolitite | 163.4 | 6.5 | 22.9 |
| Gp.6 Ditto + 300 wt % un-ammoniated zeolitite | 170.0 | 9.4 | 23. |

Statement

A large increase in the electrical conductivity is seen to occur between leachate solutions from the toxic and amended substrates; which is characteristic of soils amended with the bio-fertilizer.

This reaction is taken to infer that the nitrifying bacteria are boosted by addition of the bio-fertilizer.

A relationship is seen between shoot total nitrogen and excess zeolitite. The data shows that a fluctuation occurs between the amended substrates throughout the range of excess zeolitite.

This behaviour is not clearly understood but is apparently a function of the bacterial composition developed in the amended substrates.

Analytical data: Electrical conductivity of substrate leachate solutions and
shoot total nitrogen

| | | Shoot total nitrogen (wt %) | |
|---|---|---|---|
| Plant substrate | E.C. (μ Siemens/cm) | (Low density) | (High density) |
| Gp.1 | 119 | 0.74 | 0.98 |
| Gp.2 | 472 | 1.48 | 1.54 |
| Gp.3 | 285 | 1.17 | 1.39 |
| Gp.4 | 323 | 1.37 | 1.47 |
| Gp.5 | 189 | 1.09 | 1.38 |
| Gp.6 | 488 | 1.13 | 1.32 |

Comments on results

The plant weight results demonstrate the performance of ryegrass grown in heavy metal polluted soils of neutral to slightly alkaline pH that has been amended with zeolite bio-fertilizer.

Very large increases in plant growth occur in the amended substrates. The increase obtained in root growth is particularly important for the retention of soil particles contaminated by heavy metal residues.

However, limits are reached in the addition of un-ammoniated zeolitite above which the plants suffer deleterious effects.

As the zinc concentrations found in the shoots correlates to the behaviour of the shoot dry weights this element is thought to causing a major phytotoxic effect which is limiting growth. Although the detailed interactions between the bio-fertilizer, soil chemistry and bacterial population are still under investigation it is clear that by studying the effect of varying the concentration of the un-ammoniated zeolitite the bio-fertilizer can be formulated to provide maximum growth enhancement.

### METHOD OF SUSTAINING PLANT GROWTH IN TOXIC SUBSTRATES POLLUTED WITH HEAVY METAL ELEMENTS AS WELL AS FERTILIZATION AND BENEFICIATION OF NORMAL HORTICULTURAL AND AGRICULTURAL SOILS

The following statement is a full description of this invention, including the best method of performing it known to me.

Activities in the Industrial Age have resulted in the deposit of high levels of many metals in certain sites, to the point that human life is seriously threatened. Metal-production activities, such as mining or smelting, as well as the ubiquitous use of metals, have created many sites where toxic metals have become concentrated in soils.

In recent years, efforts have been made to develop phyto-remediation methods, e.g., the use of metal-accumulating plants called metallophytes to remove contaminating metals from sites. It has been known for some time that many plant species will concentrate certain metals in their leaves, stems and roots to a varying degree.

For heavy metals, two different types of phyto-remediation methods can be distinguished:

rhizofiltration, by concentration of heavy metals in plant roots;

photo-stabilization, the roots of the plants limiting heavy metals' availability and limiting mobility of said metals into the groundwater.

More than 400 phyto-remediators are known, most of them absorbing Nickel. The most rarely absorbed heavy metals include Manganese, Cadmium and Lead.

Various metallophytes have been tested, such as Brassicaceae (Thlaspi brachypetal, Thlaspi ochroleucum, Thlaspi caerulescens, Thlaspi rotundifolium, Cardaminopsis halleri), Caroyphyllaceae (Minuartia verna, Polycarpea synandra), Fabaceae (Astragalus Pectinatus, Astragalus bisculatus), Myriophyllium verticullatum, Pshychotrai douerreer, Viola calaminaria.

Document U.S. Pat. No. 6,917,117 relates to a method by which hyperaccumulation of metals in plant shoots such as Brassicaceae (e.g., Brassica, Sinapsis, Thlaspi, Alyssum, Eruca) is induced by exposure to phytotoxic inducing agents such as chelating agents (e.g., Roundup®) and high concentrations of heavy metals. The exposure to the inducing agent is made after a period of plant growth, as metal accumulation into plant shoots has dramatic effects on plant growth. The use of phytotoxic inducing agents as described in document U.S. Pat. No. 5,917,117 is non-ecological and potentially dangerous for the operator.

Document U.S. Pat. No. 5,711,784 discloses a method of extracting nickel, cobalt and other metals including the platinum palladium metal families from soil by phytomining. The conditions include 1) lowering the soil pH by addition of sulphur and use of ammonium N fertilizers, 2) maintaining low Ca in the soil by acidification of the soil with sulphur or sulphuric acid, and 3) applying chelating agents to the soil, such as NTA.

The method in document U.S. Pat. No. 5,711,784 is complicated and non-ecological. Document U.S. Pat. No. 5,927,005 relates to a method of removing heavy metals from soil using creosote plants (Lacrea tridentate). Again, to increase the rate of metal uptake in the plants, it is proposed to increase the acidity or to add chelators to the soil in which the creosote bushes are growing.

Other phyto-remediation techniques are described in documents WO-A-00/28093, WO-A-00/31308, WO-A-98/59080, WO-A-94/01357, EP-A-0 911 387, JP-A-57.000.190, DE-A-41.00758, DE-A-39.21336, U.S. Pat. No. 5,100,455, U.S. Pat. No. 5,320,663, U.S. Pat. No. 5,364,451, U.S. Pat. No. 5,785, 735, U.S. Pat. No. 5,809,693, U.S. Pat. No. 5,853,576, U.S. Pat. No. 5,928,406, U.S. Pat. No. 5,944,872, U.S. Pat. No. 6,117,462.

Despite increasing interest and research, several problems associated with phyto-remediation remain. For example, some metals in contaminated areas may be hardly reached via phyto-remediation because they lie beneath the rhizosphere, many of the known metal-accumulating plants being simply too small to accumulate large quantities of metals. Additionally, many of the plants thus far identified as useful in phyto-remediation are from tropical regions.

One object of the invention is to provide means of preventing surface erosion, especially for toxic substances polluted with heavy metal elements.

Another object of the invention is to provide means of promoting growth of metallophytes and other plants on toxic ground polluted by the presence of heavy metal elements.

Another object of the invention is to provide the above-mentioned means, said means being ecological and less expensive than most known bio-remediation methods.

According to the invention, there is provided a method of sustaining plant growth in toxic substrates polluted with heavy metal elements, characterized in that it comprises amendment of the toxic substrates with an organo-zeolitic mixture.

The heavy metal element(s) can be the typical ones, such as Zinc, Copper, Lead, Cadmium, Arsenic, Mercury, the organo-zeolitic mixture being added to the said polluted substrate between 5% and 60%.

The method of the present invention can be used to sustain the growth of various plants, especially plant root growth in toxic substrates polluted with heavy metal elements.

Normally, owing to the lack of available nitrogen and other essential nutrient elements, ground containing high levels of toxic metals would not sustain plant growth to a level that will prevent surface erosion. By amending the ground with the organo-zeolitic fertilizer, this condition can be overcome by growing plants with very dense root systems.

The method of the present invention can be manipulated to very the shoot-to-root ratio of the plant species used. In this respect, plants which concentrate heavy metals such as Zn, Cd and Cu in their shoots can be grown successfully and cropped to remove the metals from the rhizosphere.

The method of the present invention will enable the metal-enriched plant tissue, on ashing, to be reduced to a small volume which can be disposed of easily by mixing with zeolite-amended Portland cement and used in the production of concretes that are known to have high compressive strengths.

More precisely, after harvesting and ashing the plant, the heavy metal cations contained in the ash may be put into aqueous solution and ion-exchanged into a zeolitic tuff. The resulting zeolitic material can be dried and used to produce blended cements which have improved compressive strength and are also known to reduce the expansion caused by alkali-aggregate reactions.

It is known that natural zeolite minerals can be used as biological fertilizer (see for instance JP-A-10210855, JP-A-4197110, EP-A-444392, U.S. Pat. No. 5,082,488, U.S. Pat. No. 5,451,242, U.S. Pat. No. 5,900,387, RU-A-2 121 777, RU-A-2 132 122, RU-A-2 137 340). The preparation of an organic fertilizer incorporating zeolitic tuff is described in document U.S. Pat. No. 4,559,073, the inclusion of the zeolitic component being claimed to lower the water content of the mixture to allow effective aerobic fermentation.

Document U.S. Pat. No. 5,106,405 discloses the property of ion-exchanging ammonium ions that, via soil microbial reactions, would supply available nitrogen to plants growing in a substrate amended with a bio-fertilizer containing a zeolitic component.

The inventor has discovered that natural zeolite materials could be used to prepare a biological fertilizer which can be applied to ground contaminated with heavy metal cations to enable the sustainable growth of plants and to control the development of shoot-to-root in such a way that plant morphology can be adjusted to either maximize soil retention by dense root growth or increase the foliage uptake of toxic heavy metal ions.

If untreated, such ground will not support vegetation and becomes subject to surface erosion by wind and rain. Toxic material transported by these agents into local drainage patterns is thus isolated and therefore uncontrollable.

Specific implementation of the invention will now be described, by way of the invention as claimed herein. Any variations in the exemplified compositions and methods which occur to the man skilled in the art are intended to fall within the scope of the present invention.

Example:

A clay-rich toxic soil containing: 2.87% Organic matter, 1.1% Calcium carbonate, 2.2% total Iron, 28.9 mg.kg-1 Zinc, 670 mg.kg-1 Lead, 12.2% mg.kg-1 Cadmium and 18.9 mg.kg-1 Arsenic has been amended with 16.7% organo-zeolitic fertilizer.

Organo-zeolitic fertilizer is prepared as follows:

Animal waste, e.g., chicken manure, is composted together with crushed zeolitic tuff containing the zeolite Ca, K, Clinoptilolite in a ratio of 1:2 (by volume) i.e., tuff to manure. The materials are mixed together with enough water to make the pile damp and choppen straw is added. Air is forced through the pile from (a) perforated plastic pipe(s) laid inside the pile during construction and the reaction is carried out under cover. This could prevent saturation of the pile with rain water.

The pile reaches 50-70° C. and then the temperature drops to ambient, at which stage the composted material is dry, friable, odourless and ready for use as an organo-zeolitic fertilizer.

Spring Wheat (Triticum aestivum L., cv. Red Fife) was sown in two-kilogram substrates. Wheat grown in the untreated soil was used for comparison. The plants were grown in 255 mm-diameter pots, replicated four times, under ordinary lighting conditions in a greenhouse. Watering, with de-ionized water, was by weight to field capacity (180 ml per 2-kg substrate) and the pots were placed in shallow trays to retain leachate. Watering, generally on a daily basis, prevented the plants from drying out and any water running from the pots was returned to the substrate surface with little loss. Plants were harvested on a regular basis each month and the shoot weights were recorded after drying to constant weight at 70° C.

One month after germination the substrates were leached with 400 ml of de-ionized water (pH=8.4) and, after removal of fine colloidal particles, were analyzed chemically. Two further leachate collections were made at monthly intervals over a three-month growth period.

Leachate chemistry at the third harvest

| | | | |
|---|---|---|---|
| Toxic substrate | N conc | 0.23 | mg/l |
| Amended substrate | N conc | 178.00 | mg/l |
| Toxic substrate | K conc | 17.38 | mg/l |
| Amended substrate | K conc | 66.70 | mg/l |
| Toxic substrate | Ca conc | 20.40 | mg/l |
| Amended substrate | Ca conc | 253.00 | mg/l |
| Toxic substrate | Mg conc | 2.69 | mg/l |
| Amended substrate | Mg conc | 27.10 | mg/l |
| Toxic substrate | pH 7.8 | E.C. 149 | μS/cm |
| Amended substrate | pH 7.2 | E.C. 2077 | μS/cm |

These results demonstrate the degree of mobilization of major cations in the amended soil solution.

In the case of the metal trace elements, a general decrease is seen in the leachates between high concentrations in the toxic substrates and low concentrations in the amended substrates. An example is shown below for Zinc.

| | | |
|---|---|---|
| Toxic substrate: | Zn conc | 0.65 mg/l |
| Amended substrate: | Zn conc | 0.65 mg/l |

Following the analysis of the leachates, the chemical analyses of the plant shoots express the way in which nutrient and trace metal elements are taken up from the respective substrates.

Plant shoot chemistry at the third harvest

| | Amended Substrate | | Toxic Substrate | |
|---|---|---|---|---|
| N conc | 2.19 | wt % | 1.16 | wt % |
| K conc | 35.33 | mg/g | 18.20 | mg/g |
| Ca conc | 5.82 | mg/g | 2.82 | mg/g |
| Mg conc | 1.24 | mg/g | 0.85 | mg/g |
| Zn conc | 124 | μg/g | 67 | μg/g |
| Pb conc | 5 | μg/g | 3 | μg/g |
| Cu conc | 17 | μg/g | 5 | μg/g |

The plant shoot chemistry can now be compared to the established nutrient range for Spring Wheat.

| | % dry wt | | | | | μg/g | |
|---|---|---|---|---|---|---|---|
| | N | P | K | Ca | Mg | Zn | Cu |
| Adequate | 3.0-4.5 | 0.3-0.5 | 2.9-3.8 | 0.4-1.0 | 0.15- | 20-70 | 5-10 |
| range | | | | | 0.3 | | |
| Toxic | 1.16 | 0.5 | 1.80 | 0.3 | 0.10 | 67 | 5 |
| substrate | | | | | | | |
| Amended | 2.19 | 0.3 | 3.50 | 0.6 | 0.12 | 124 | 17 |
| substrate | | | | | | | |

Shoot dry weight recorded at monthly harvests

| | Dry weight (g/plant) |
|---|---|
| 1st harvest | |
| Toxic substrate: | 0.26 |
| Amended substrate: | 0.89 |
| 2nd harvest | |
| Toxic substrate: | 0.52 |
| Amended substrate: | 5.36 |
| 3rd harvest | |
| Toxic substrate: | 1.03 |
| Amended substrate: | 6.77 |

Comments on example

The type of organo-zeolitic fertilizer of the present invention can be adapted to grow plants with a dense root system on toxic soils that cannot normally supply sufficient plant nutrients to support such growth. This is achieved by microbiological means only, as no inorganic mineral salts have been added.

It can be seen from the chemistry of the plant shoots that when the available nitrogen in the substrate is some 35% below the adequate range, a dense root system (in the case of Spring Wheat) is formed. As the percentage of organo-zeolitic material added to the toxic soil can be altered, the concentration of available nitrogen can be adjusted to suit the plant species concerned. If maximum shoot growth is required, then the percentage of organo-zeolitic material can be adjusted upwards to put the nitrogen concentration into the adequate range. This would be desired if maximum plant uptake was required in order to remove heavy metals from the rhizosphere.

The trace element concentrations of Zinc and Copper in the plant shoots show that the mobilization of cations in the soil solution, due to the microbial activity of the organo-zeolitic material, make these elements available to the plant. On harvesting, the soil will be partially depleted in these elements and in time the rhizosphere will become less polluted. The volume of plant material after harvest can be greatly reduced by ashing and can be safely stored or possibly recycled.

As it is known that the addition of finely crushed zeolitic tuff to Portland cement improves its physical and chemical properties, the suggestion is made that heavy metal cations remaining in the plant ash could be exchanged into zeolitic tuff which is afterwards used for such a purpose.

Possible explanation

A proposed explanation of the above-mentioned results is given below, the detailed mechanism still being the subject of research by the inventor. During organo-zeolitic fertilizer preparation, choppen straw likely provides a source of carbon to support bacterial growth. Ammonifying bacteria (as typified by Clostridium and Penicillium) acting on the organic material decompose proteins, amino sugars and nucleic acids to ammonia. The ammonia in the cationic form NH4+ is ion-exchanged into the zeolite where it is held, loosely bound, within the pore space of the crystal lattice. The bacterial activity causes the increase of temperature up to 50-70° C., the completion of the reaction being reached as the temperature drops to ambient.

On addition of the fertilizer to a plant substrate, the NH4++ ions held in the zeolite pore space diffuse at an exponential rate into the substrate. Nitrifying bacteria present in the organo-zeolitic component use the diffusing NH4+ to produce a large source of nitrate that is used in plant growth. As a consequence of the bacterial reactions, free hydrogen ions (protons) are liberated and mobilize the soil solution, causing the dissociation of metal cations present in the substrate.

The inventor has demonstrated how the organo-zeolitic fertilizer can be used with soils polluted with heavy metals such as Zinc, Cadmium, Copper and Lead. The inventor has now found that when 16-17% organo-zeolitic fertilizer is added to such soils, similar effects occur which greatly increase nitrate concentration and mobilize metal cations in the soil solution.

Amending a toxic soil in this way slightly lowers the pH of the soil solution but increases its electrical conductivity by an order of magnitude. At the level of amendment quoted (16-17%), twice the amount of available nitrogen present in the toxic soil is provided. This increase is 35% below the adequate range for Spring Wheat (Triticum aestivum L., cv. Red Fife) and has the effect of maximizing the root/shoot ratio. In this way a dense root system can be developed. By increasing the amount of organo-zeolitic fertilizer added to the soil, the root-to-shoot ratio can be decreases, in which case shoot growth is favoured.

Cation mobilization in the soil solution provides the growing plant with nutrients such as Potassium, Calcium, Magnesium and Zinc, and the plant's requirement acts to buffer the system against concentration of these elements and diffusion from the rhizosphere. By increasing the level of plant nutrients in this way a healthy plant can be grown and sustained on toxic soils polluted with heavy metals. In the case of Zinc and Copper, the inventor has observed that these elements are taken up by the plant at a rate that can be tolerated, and the damage occurring in the same plants grown in the toxic soil is not seen. This property can be used to remove heavy metal elements from the rhizosphere by harvesting the plant. The plant material can be greatly reduced in volume by ashing without loss of the heavy metals and incorporated in a mixture of Portland cement and finely crushed zeolitic tuff. In this way, concrete of high compressive strength and low alkali reactivity can be made and used to store the heavy metal elements.

Land contaminated, poisoned and polluted by industrial and mining operations is a terrible problem. These toxic sites are an extreme danger to the environment and to the health of people who live nearby.

These toxic lands, upon which only very sparse vegetation can grow (if it can grow at all), have erosion rates 100 to 1000 times higher than lands covered by full-rooted, permanent vegetation.

It is vital to fully realize that once these poisonous metals (lead, mercury, cadmium, zinc, copper, nickel, etc.) are blown as a fine dust by the wind, they are impossible to control. The result is contamination and pollution of the air we breathe, the water we drink (and eventually the ground water), and inevitably the food chain itself. It is, therefore, crucial to develop a method which treats the problem in situ.

A very important part of the invention is to treat toxic substrates polluted with heavy metal elements in situ. Contaminated surface sites have erosion rates which are 100 to 1000 times higher than on land covered by permanent vegetation. Native grasses and plants planted with our organo-zeolitic mixture increase the root growth significantly and increase the retention of soil particles and heavy metals, thus they will remain in situ.

Acidic soils present a particularly difficult problem to overcome in the revegetation of soils contaminated with mine wastes. This is often due to the continual oxidation of sulphide minerals, generating sulphuric acid which lowers the pH of the soil solution. Nitrification rates begin to decrease below pH 6.0 and become negligible below 4.5. The consequence is that it becomes impossible to grow plants in soils with pH values below 3. Recent work has shown that the zeolitic component of the bio-fertilizer acts to increase soil pH to a level at which nitrifying bacteria can survive and multiply.

Statement

Work on Ryegrass (Lolium perenne L.) has shown that amendment of the plant substrate with the zeolite bio-fertilizer will enhance plant growth in a similar way to that seen with Spring Wheat (Triticum aestivum L., cv. Paragon).

Dense root systems can be sustained in soils polluted with heavy metals. The contaminated substrate used was identical to that in the spring wheat programme as described in the above patent.

In the ryegrass programme, unammoniated zeolitite (i.e., zeolitized volcanic tuff containing the zeolite mineral clinoptilolite) was added in varying proportions to the initial amended substrate containing 16-17 vol. % organo-zeolitic fertilizer (zeolite bio-fertilizer).

The exchangeable cations in the clinoptilolite used are Calcium and Potassium. Zeolite minerals with appreciable quantities (>ca2 Wt %) are undesirable as reactions in the plant substrate increase the sodium availability which can cause depression in growth. The typical formula of the clinoptilolite used is (K_{1.9} Ca_{1.3} Na_{0.4} Mg_{0.1}) Al_{6.1} Si₂₉₉ O₇₂ 23.1 H₂O.

It was found that the relationship between shoot dry weight and weight % excess zeolitite defined the (cut-off) limit of growth enhancement above which continued addition of zeolitite diminished plant growth.

This effect was found to vary according to plant density. A low-density group (25 plants/pot) had a higher cut-off limit than a high-density group (ca. 600 plants/pot).

The low-density plants also showed greater growth enhancement than the high-density group.

Analytical data: Shoot dry weights

| | Shoot |
|---|---|
| Plant substrate | weight (g) |
| i) Low density group harvested at four months. | |
| Gp.1 Toxic substrate | 7.38 |
| Gp.2 Amended substrate (16-17) vol % zeolite bio- | 31.46 |
| fertilizer | |
| Gp.3 Ditto + 75 wt % un-amoniated zeolitite | 32.73 |
| Gp.4 Ditto + 150 wt % un-amoniated zeolitite | 33.36 |
| Gp.5 Ditto + 225 wt % un-ammoniated zeolitite | 33.98 |
| Gp.6 Ditto + 300 wt % un-ammoniated zeolitite | 28.87 |
| (ii) High density group harvested at five months. | |
| Gp.1 Toxic substrate | 6.76 |
| Gp.2 Amended substrate (16-17) vol % zeolite bio-fertilizer | 25.83 |
| Gp.3 Ditto + 75 wt % un-ammoniated zeolitite | 36.49 |
| Gp.4 Ditto + 150 wt % un-ammoniated zeolitite | 25.46 |
| Gp.5 Ditto + 225 wt % un-ammoniated zeolitite | 25.10 |
| Gp.6 Ditto + 300 wt % un-ammoniated zeolitite | 24.51 |

Statement

The root systems in the low-density group show a decline in root mass above an excess addition of 150 wt % unammoniated zeolitite.

As in the case of the shoot mass, a distinct cut-off is seen in root growth. In the present case, working with heavy metals in the specified range in neutral to slightly alkaline conditions, no advantage is gained in increasing the excess zeolitite above 150 wt %. Shoot growth is maximized at 225 wt % excess zeolitite. This again demonstrates that the bio-fertilizer can be formulated to maximize either shoot or root growth.

In order to formulate the bio-fertilizer for these effects, it will be necessary to conduct initial laboratory trials as the biological factors (i.e., remedial plant species and density), bacterial population, soil properties, heavy metal species and concentrations will vary independently at specific sites.

Analytical data: Root dry weights

| | Root |
|---|---|
| Plant substrate | weight (g) |
| (i) Low density group harvested at five months. | |
| Gp.1 Toxic substrate | 3.45 |
| Gp.2 Amended substrate (16-17) vol % zeolite bio-fertilizer | 6.53 |
| Gp.3 Ditto + 75 wt % un-ammoniated zeolitite | 8.43 |
| Gp.4 Ditto + 150 wt % un-ammoniated zeolitite | 11.80 |
| Gp.5 Ditto + 225 wt % un-ammoniated zeolitite | 11.67 |
| Gp.6 Ditto + 300 wt % un-ammoniated zeolitite | 7.44 |

Statement

Harvested plant shoots in the high-density group were analyzed for trace concentrations of Zinc, Copper and Lead. By relating the trace metal chemistry to the shoot dry weight of the amended groups it was found that the cut-off limit corresponded to a concentration of 138 μg.g₋₁ Zinc. Above this value, shoot dry weight dropped dramatically.

Analytical data: Trace metal chemistry in shoots

| | μg. g⁻¹ | | |
|---|---|---|---|
| Plant substrate | Zn | Pb | Cu |
| Gp.1 Toxic substrate | 74.2 | 6.7 | 16.1 |
| Gp.2 Amended substrate (16-17) vol % zeolite bio- | 106.7 | 6.8 | 22.2 |
| fertilizer | | | |
| Gp.3 Ditto + 75 wt % un-ammoniated zeolitite | 138.1 | 6.1 | 26.0 |
| Gp.4 Ditto + 150 wt % un-ammoniated zeolitite | 140.6 | 7.6 | 24.6 |
| Gp.5 Ditto + 225 wt % un-ammoniated zeolitite | 163.4 | 6.5 | 22.9 |
| Gp.6 Ditto + 300 wt % un-ammoniated zeolitite | 170.0 | 9.4 | 23.0 |

Statement

A large increase in the electrical conductivity is seen to occur between leachate solutions from the toxic and amended substrates; which is characteristic of soils amended with the bio-fertilizer.

This reaction is taken to infer that the nitrifying bacteria are boosted by addition of the bio-fertilizer.

A relationship is seen between shoot total nitrogen and excess zeolitite. The data shows that a fluctuation occurs between the amended substrates throughout the range of excess zeolitite.

This behaviour is not clearly understood but is apparently a function of the bacterial composition developed in the amended substrates.

| | | Shoot total nitrogen (wt %) | |
|---|---|---|---|
| Plant substrate | E.C. (μSiemens/cm) | (Low density) | (High density) |
| Gp.1 | 119 | 0.74 | 0.98 |
| Gp.2 | 472 | 1.48 | 1.54 |
| Gp.3 | 285 | 1.17 | 1.39 |
| Gp.4 | 323 | 1.37 | 1.47 |
| Gp.5 | 189 | 1.09 | 1.38 |
| Gp.6 | 488 | 1.13 | 1.32 |

Comments on results

The plant weight results demonstrate the performance of ryegrass grown in heavy metal-polluted soils of neutral to slightly alkaline pH that has been amended with zeolite bio-fertilizer.

Very large increases in plant growth occur in the amended substrates. The increase obtained in root growth is particularly important for the retention of soil particles contaminated by heavy metal residues. However, limits are reached in the addition of unammoniated zeolitite above which the plants suffer deleterious effects.

As the zinc concentrations found in the shoots correlate to the behaviour of the shoot dry weights, this element is thought to cause a major phytotoxic effect which is limiting growth. Although the detailed interactions between the bio-fertilizer, soil chemistry and bacterial population are still under investigation, it is clear that by studying the effect of varying the concentration of the unammoniated zeolitite the bio-fertilizer can be formulated to provide maximum growth enhancement.

Continuing study by the inventor, Peter J. Leggo, has revealed that a substantial additional growth enhancement can be achieved by increasing the content of unammoniated zeolitic tuff in the zeolite bio-fertilizer amended substrate.

In the case of Spring Wheat (Triticum aestivum L., cv. Red Fife), the additional increase in shoot dry weight relative to plants grown in a garden soil substrate amended with 16.7 wt % zeolite bio-fertilizer was found to be 48.8 wt %. A similar relative increase of 38.0 wt % was found to also occur in the root system. This effect was produced by increasing the unammoniated zeolite tuff content of the substrate by 65.0 wt %.

A similar but more diverse effect was seen in Ryegrass (Lolium perenne L.) grown in metal-contaminated soil. In this case, shoot dry weight was seen to increase by 8.0 wt % when the unammoniated zeolite content was increased to 175.0 wt %. However, a dramatic effect was seen in the root system, as by increasing the unammoniated zeolitic tuff content to 125.0 wt % a relative increase of 80.7 wt % in root dry weight occurred.

As the zeolitic tuff additions contain no additional ammonia, the system must be benefiting from another property. A possible explanation is that the zeolitic water held in the channel structure is acting to “buffer” the loss of soil water by evaporation, in which case as the loss of soil water is slowed down the bacterial population will remain active for a longer period. Also, it was noticed that the substrates containing extra zeolitic tuff were draining faster than the unamended soil control which suggests that the soil porosity is increased by the presence of the zeolitic tuff. As nitrifying bacteria are chiefly aerobic, it is thought that an increased porosity will also benefit the population.

In order to test the function of zeolitic water, a series of measurements were made with a soil tensiometer to record the rate of loss of soil moisture. It was found that the presence of 65.0 wt % excess unammoniated zeolitic tuff decreased the rate of change of suction pressure, relative to an unamended garden soil substrate, by 45.5%. It can be inferred from this data that the presence of the zeolitic tuff has had a marked effect on the loss of soil moisture by evaporation. Work continues in order to quantify this effect.

Analytical data

| | | |
|---|---|---|
| Sample | Shoot (g) | Root (g) |

(a) Dry weights, Spring Wheat grown in uncontaminated soil

| C.Gp1 | Unamended | 1.42 ± 0.26 | 0.14 ± 0.04 |
|---|---|---|---|
| C.Gp2 | Plus 16.7% bio-fertilizer | 7.67 ± 1.80 | 0.50 ± 0.16 |
| C.Gp3 | Ditto + 65% excess zeolitic tuff | 11.41 ± 2.25 | 0.69 ± 0.06 |
| C.Gp4 | Ditto + 125% excess zeolitic tuff | 11.32 ± 1.63 | 0.74 ± 0.19 |
| C.Gp5 | Ditto + 175% excess zeolitic tuff | 10.83 ± 2.17 | 0.72 ± 0.13 |
| C.Gp6 | Ditto + 225% excess zeolitic tuff | 12.50 ± 0.28 | 0.98 ± 0.35 |
| | Sample | Shoot (g) | Root (g) |

(b) Dry weights, Ryegrass grown in contaminated soil

| | | | |
|---|---|---|---|
| C.Gp1 | Unamended | 7.38 | 3.45 |
| C.Gp2 | Plus 16.7% bio-fertilizer | 31.46 | 6.53 |
| C.Gp3 | Ditto + 65% excess zeolitic tuff | 32.73 | 8.43 |
| C.Gp4 | Ditto + 125% excess zeolitic tuff | 33.36 | 11.80 |
| C.Gp5 | Ditto + 175% excess zeolitic tuff | 33.98 | 11.67 |
| C.Gp6 | Ditto + 225% excess zeolitic tuff | 28.87 | 7.44 |

| | | | |
|---|---|---|---|
| | | Change in Tension Pressure | |
| Sample | Time (hr) | (kPa) | Rate (kPa · hr⁻¹) |

(c) Tensiometer measurements

| | | | |
|---|---|---|---|
| C.Gp1 | 120 | 66.2 | 0.55 |
| C.Gp2 | 216 | 72.5 | 0.34 |
| C.Gp3 | 264 | 78.5 | 0.30 |

Continuing study by the inventor [Peter J. Leggo] has revealed that a substantial additional growth enhancement can be achieved by increasing the content of un-ammoniated zeolitic tuff in the zeolite bio-fertilizer amended substrate.

In the case of Spring Wheat (Triticum aestivum L., cv. Red Fife) the additional increase in shoot dry weight relative to plants grown in a garden soil substrate amended with 16.7 wt % zeolite bio-fertilizer was found to be 18.8 wt %. A similar relative increase of 38 wt % was found to also occur in the root system. This effect was produced by increasing the un-ammoniated zeolite tuff content of the substrate by 65 wt %.

No large further growth enhancement, within experimental error, was found by increasing the un-ammoniated zeolitic tuff content above 65 wt %.

A similar but more diverse effective was seen in Ryegrass (Lolium perenne L.) grown in metal contaminated soil. In this case shoot dry weight was seen to increase by 8.0 wt % when the un-ammoniated zeolite content was increased to 175 wt %. However a dramatic effect was seen in the root system as by increasing the un-ammoniated zeolitic tuff content to 125 wt % a relative increase of 80.7 wt % in root dry weight occurred.

As the zeolitic tuff additions contain no additional ammonia the system must be benefiting from another property. A possible explanation is that the zeolitic water held in the channel structure is acting to “buffer” the loss of soil water by evaporation. In which case as the loss of soil water is slowed down the bacterial population will remain active for a longer period. Also, it was noticed that the substrates containing extra zeolitic tuff were draining fasted that the unamended soil control which suggests that the soil porosity is increased by the presence of the zeolitic tuff. As nitrifying bacteria are chiefly aerobic it is thought that an increased porosity will also benefit the population.

In order to test the function of zeolitic water a series of measurements were made with a soil tensiometer to record the rate of loss of soil moisture. It was found that the presence of 65 wt % excess un-ammoniated zeolitic tuff decreased the rate of change of suction pressure, relative to an un-amended garden soil substrate, by 45.5%. It can be inferred from this data that the presence of the zeolitic tuff has had a marked effect on the loss of soil moisture by evaporation. Work continues in order to quantify my discovery further.

Analytical data

| | | |
|---|---|---|
| Sample | Shoot (g) | Root (g) |

(a) Dry weights, Spring Wheat grown in uncontaminated soil

| C.Gp1 | Unamended | 1.42 ± 0.26 | 0.14 ± 0.04 |
|---|---|---|---|
| C.Gp2 | Plus 16.7% bio-fertilizer | 7.67 ± 1.80 | 0.50 ± 0.16 |
| C.Gp3 | Ditto + 65% excess zeolitic tuff | 11.41 ± 2.25 | 0.69 ± 0.06 |
| C.Gp4 | Ditto + 125% excess zeolitic tuff | 11.32 ± 1.63 | 0.74 ± 0.19 |
| C.Gp5 | Ditto + 175% excess zeolitic tuff | 10.83 ± 2.17 | 0.72 ± 0.13 |
| C.Gp6 | Ditto + 225% excess zeolitic tuff | 12.50 ± 0.28 | 0.98 ± 0.35 |
| | Sample | Shoot (g) | Root (g) |

(b) Dry weights, Ryegrass grown in contaminated soil

| | | | |
|---|---|---|---|
| C.Gp1 | Unamended | 7.38 | 3.45 |
| C.Gp2 | Plus 16.7% bio-fertilizer | 31.46 | 6.53 |
| C.Gp3 | Ditto + 65% excess zeolitic tuff | 32.73 | 8.43 |
| C.Gp4 | Ditto + 125% excess zeolitic tuff | 33.36 | 11.80 |
| C.Gp5 | Ditto + 175% excess zeolitic tuff | 33.98 | 11.67 |
| C.Gp6 | Ditto + 225% excess zeolitic tuff | 28.87 | 7.44 |

| | | | |
|---|---|---|---|
| | | Change in Tension Pressure | |
| Sample | Time (hr) | (kPa) | Rate (kPa · hr⁻¹) |

(c) Tensiometer measurements

| | | | |
|---|---|---|---|
| C.Gp1 | 120 | 66.2 | 0.55 |
| C.Gp2 | 216 | 72.5 | 0.34 |
| C.Gp3 | 264 | 78.5 | 0.30 |

1. A method of sustaining plant growth in toxic substrates polluted with heavy metal elements, characterized in that it comprises amendment of the toxic substrates with an organo-zeolitic mixture.

2. The method of claim 1, wherein the heavy metal element is Zinc, Copper, Lead, Cadmium, Arsenic.

3. The method of claim 1 or 2, wherein the organo-zeolitic compound comprises the zeolite mineral Ca-K clinoptilolite and animal waste.

4. The method of claim 3, wherein the animal waste comprises chicken manure.

5. The method of claim 3 or 4, wherein the organo-zeolitic compound is prepared by composting animal waste with crushed zeolitic tuff.

6. The method of claim 5, wherein the ratio by volume of tuft to animal waste is roughly 1:2.

7. The method of claim 5 or 6, wherein a source of carbon is mixed with zeolitic tuft and animal waste.

8. The method of claim 7, wherein said source of carbon comprises choppen straw.

9. The method of any one of claims 1 to 7, wherein said organo-zeolitic compound is added to said polluted substrates between 10% and 25%.

10. Use of the method defined in any of claims 1 to 9 to sustain growth of Spring Wheat.

11. Use of the method defined in any of claims 1 to 9 to sustain growth of metallophyte plants, with metal-containing metallophyte plant tissues being collected and removed at appropriate intervals.

12. Use of the method defined in claim 11, wherein heavy metal cations remaining in the plant ash are exchanged into zeolitic tuft to be added to a cement or equivalent.

13. The addition of excess un-ammoniated zeolitite increased the growth enhancement factor with the zeolite bio-fertilizer in the original compositonal form, i.e., substrate containing 16-17 vol % of the organo-zeoligic mixture.

14. Cut-off limits for the amount of excess un-ammoniated zeolitite to produce maximum growth can be specified.

15. These limits vary according to plant density, plant species, metal contaminant species, metal element concentration, soil physical and chemical properties.

16. By analysis of the parameters given in claim 15 it is possible to formulate the amendment to achieve either maximum shoot or root growth on a specific waste site containing heavy metal residue.

17. By achieving maximum root density, soil retention will be maximized. In this way, heavy metal pollutants will remain in situ and protected from erosional forces that cause transportation.

18. The invention alters the pH content in highly acidic soils, permitting vegetation to grow.

19. The bio-fertilizer can be used to beneficiate and fertilize non-toxic soils.
